(19) United States
(12) Patent Application Publication
(10) Pub. No.: US 2007/0109413 A1
(43) Pub. Date: May 17, 2007

(54) PORTABLE ELECTRONIC DEVICE WITH CAMERA MODULE

(75) Inventor: Jen-Tsorng Chang, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,690

(22) Filed: Sep. 12, 2006

(30) Foreign Application Priority Data
Nov. 11, 2005 (CN) 200510101234.6

(51) Int. Cl. H04N 5/225

(52) U.S. Cl. 348/207.99

(57) ABSTRACT

A portable electronic device (100) includes a body (20) and a camera module (10). The body includes an opening (210), the camera module is mounted in the opening. The camera module includes a first lens module (60), a second lens module (70), a stationary base (40), a moveable base (50) and an image sensing module (90); the moveable base is installed in the stationary base and is moveable within the stationary base; the first lens module and the second lens module are installed on the moveable base, the image sensing module is installed on the stationary base; the moveable base can move in the stationary base, thus enabling the image sensing module to be selectively aligned with the first lens module or the second lens module.

### 1. FIELD OF THE INVENTION

The present invention relates generally to portable electronic devices and, more particularly, to a portable electronic device with a camera module.

### 2. DESCRIPTION OF RELATED ART

With the ongoing development of microcircuitry and multimedia technologies, digital cameras are now in widespread use. High-end portable electronic devices, such as mobile phones and personal digital assistants (PDAs), are being developed to be increasingly multi-functional. Many of these portable electronic devices are now equipped with a digital camera module. These electronic devices enable consumers to enjoy capturing digital pictures anytime and anywhere. At the same time, demand for digital picture quality has become greater and greater.

Generally, a digital camera module used in a portable electronic device includes an image sensor. The image sensor may be a charge coupled device (CCD) image sensor or a complementary metal oxide semiconductor (CMOS) image sensor. The image sensor receives various optical signals including visible optical signals and infrared signals. Therefore, the images taken by the digital camera module are obviously different to the images seen by the eyes, unless the infrared signals are filtered out when the portable electronic device is used for taking photos.

Most camera modules generally include a first filter to prevent the infrared signals from being received by the image sensor. However, camera modules including such a first filter are difficult to take clear and bright photos in poor light conditions. A flash lamp can be installed in the portable electronic device for illumination to improve quality of the photos taken by the portable electronic device, but long term exposure to the flaring of the flash lamp may possibly damage the eyes of the user. Additionally, the flash lamp is likely to shorten the life-span of the battery of the portable electronic device.

Therefore, a new portable electronic device with a camera module is desired in order to overcome the above-described shortcomings.

### SUMMARY OF THE INVENTION

In a preferred embodiment thereof, a portable electronic device includes a body and a camera module. The body includes an opening, the camera module is mounted in the opening. The camera module includes a first lens module, a second lens module, a stationary base, a moveable base and an image sensing module; the moveable base is installed in the stationary base and is moveable within the stationary base; the first lens module and the second lens module are installed on the moveable base, the image sensing module is installed on the stationary base; the moveable base can move in the stationary base, thus enabling the image sensing module to be selectively aligned with the first lens module or the second lens module.

Other advantages and novel features will become more apparent from the following detailed description when taken in conjunction with the accompanying drawings.

### BRIEF DESCRIPTION OF THE DRAWINGS

Many aspects of the portable electronic device can be better understood with reference to the following drawings. The components in the drawings are not necessarily drawn to scale, the emphasis instead being placed upon clearly illustrating the principles of the lens module. Moreover, in the drawings, like reference numerals designate corresponding parts through out the several views.

FIG. 1 is a schematic view of a portable electronic device in accordance with a first embodiment of the present invention;

FIG. 2 is a cut-away view of a first state of the camera module shown in FIG. 1;

FIG. 3 is a cut-away view along the line 111-111 shown in FIG. 2;

FIG. 4 is a cut-away view of a second state of the camera module shown in FIG. 1; and

FIG. 5 is a schematic view of a portable electronic device in accordance with a second embodiment of the present invention.

### DETAILED DESCRIPTION OF THE INVENTION

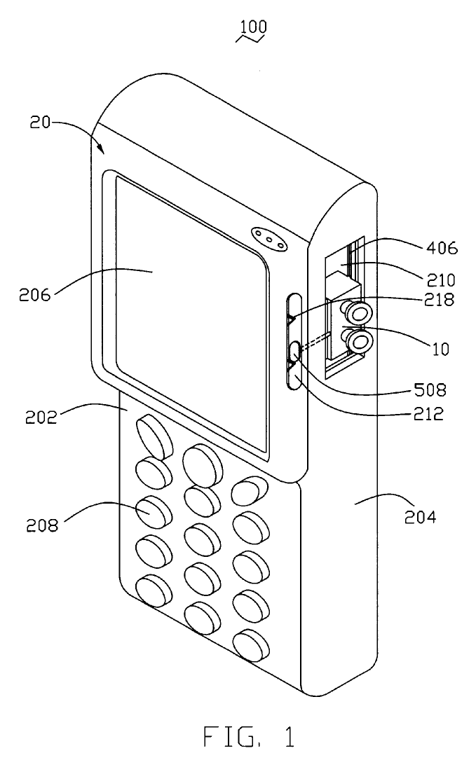

Referring now to the drawings in detail, FIG. 1 shows a mobile phone 100 in accordance with a first embodiment of the present portable electronic device. The mobile phone 100 includes a body 20 and a camera module 10. The body 20 includes a face 202 and two side faces 204. A screen 206 and a plurality of buttons 208 are installed on the face 202. An opening 210 is defined on one side face 204, and the camera module 10 is installed in the opening 210. A slot 212 is defined on the face 202, and the slot 212 is located adjacent to the opening 210. Two retainers 218 are formed at two opposing ends of the slot 212 respectively.

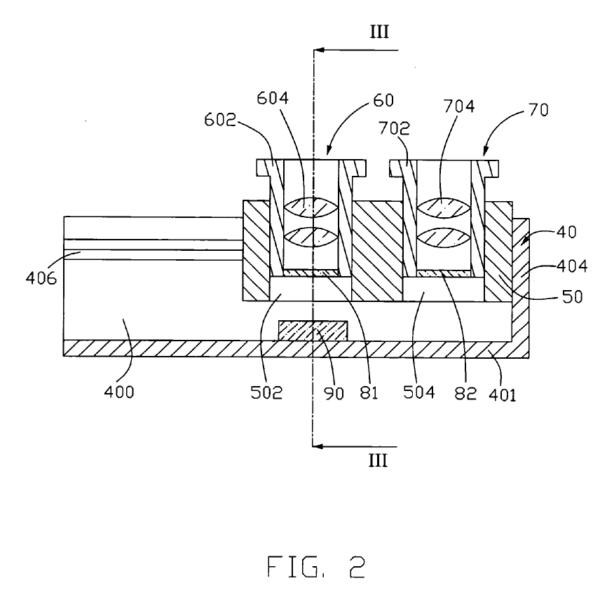

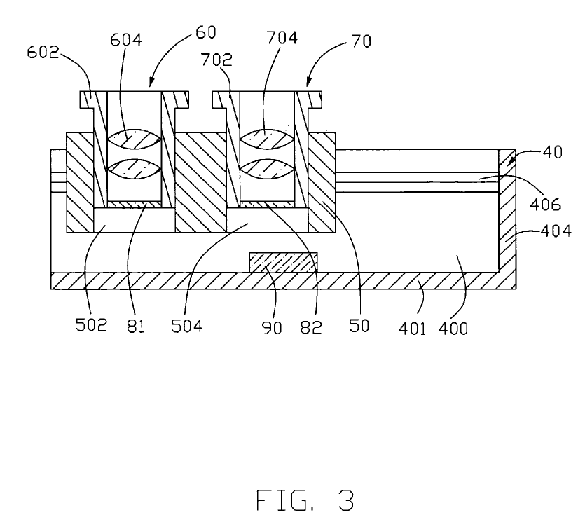

Referring FIG. 2 and FIG. 3, the camera module 10 includes a stationary base 40, a moveable base 50, a first lens module 60, a second lens module 70, a first filter 81, a second filter 82 and an image sensing module 90.

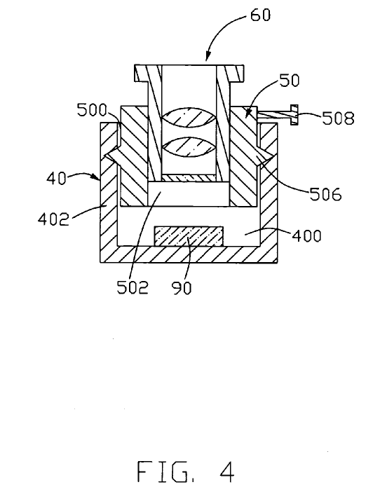

Referring also to FIG. 4, the stationary base 40 is a rectangular housing that defines a receiving cavity 400 therein. The stationary base 40 includes a floor board 401 and two parallel side walls 402 located adjacent to the floor board 401. Each side wall 402 defines a sliding groove 406 in an inner surface. Each sliding groove 406 has a V-shaped cross section and extends along a direction parallel to the floor board 401. The sliding grooves 406 run through two ends of the stationary base 40.

The moveable base 50 is a rectangular housing including two parallel side surfaces 500. The moveable base 50 defines a first hole 502 and a second hole 504. The first hole 502 and the second hole 504 both run through the moveable base 50. Axes of the first hole 502 and the second hole 504 are both parallel to the side surfaces 500, and screw thread (not shown) is formed in the first hole 502 and the second hole 504. The moveable base 50 also defines two sliding rails 506 formed with each corresponding to a sliding groove 406 on each side surface 500. Each sliding rail 506 has a V-shaped cross section and runs through two ends of the moveable base 50. The sliding rails 506 extend along a line connecting the centers of the first hole 502 and the second hole 504. An operating pole 508 is mounted on one side surface 500.

The first lens module 60 includes a first barrel 602 and a first lens group 604. Screw thread (not shown) is formed on the outer surface of the first barrel 602. The first lens group 604 including a plurality of lenses is installed in the first barrel 602. The first filter 81 is also installed in the first barrel 602 and located in an emitting light path of the first lens module 60. Infrared signals are screened from incoming light by the first filter 81 and visible optical signals are allowed to pass through the first filter 81.

The second lens module 70 includes a second barrel 702 and a second lens group 704. Screw thread (not shown) is formed on the outer surface of the second barrel 702. The second lens group 704 including a plurality of lenses is installed in the second barrel 702. The second filter 82 is also installed in the second barrel 702 and located in an emitting light path of the second lens module 70. Infrared signals are allowed to pass through the second filter 82 and visible optical signals are screened from incoming light by the second filter 82.

The image sensing module 90 may be a charge coupled device (CCD) image sensor or a complementary metal oxide semiconductor (CMOS) image sensor. The image sensing module 90 is installed on a centre of the floor board 401.

In assembly, the first lens module 60 is mounted into the first hole 502 via engagement between screw thread of the first barrel 602 and the screw thread of the first hole 502, and the second lens module 70 is mounted into the second hole 504 via engagement between screw thread of the second barrel 702 and the screw thread of the second hole 504. Each sliding rail 506 of the moveable base 50 is engaged in a sliding groove 406 of the stationary base 40, thus the moveable base 50 is installed on the stationary base 40 and can slide along the sliding grooves 406 of the stationary base 40. The stationary base 40 is mounted into the opening 210 of the body 20, and the moveable base 50 is exposed through the opening 210. The sliding pole 508 of the moveable base 50 extends out of the slot 212. The sliding pole 508 can slide along the slot 212, when the sliding pole 508 slides to the ends of the slot 212, the retainers 218 retain the sliding pole 508.

In use, when the mobile phone 100 is used to take photos in bright circumstances, the operating pole 508 of the moveable base 50 is pushed to slide to an end of the slot 212, thus the sliding rails 506 of the moveable base 50 slides along the sliding grooves 406 of the stationary base 40, and the moveable base 50 moves on the stationary base 40. When the operating pole 508 is pushed to the end of the slot 212, a retainer 218 retains the operating pole 508 in the end. In this place, the first lens module 60 is aligned with the image sensing module 90, infrared signals are filtered by the first filter 81, visible optical signals are focused by the first lens group 604 and received by the image sensing module 90. In this way, the camera module 10 receives images formed by visible optical signals. When the mobile phone 100 is used to take photos in dark circumstances, the operating pole 508 is pushed to slide to another end of the slot 212, thus the sliding rails 506 slides along the sliding grooves 406, and the moveable base 50 moves on the stationary base 40. When the operating pole 508 is pushed to the end of the slot 212, another retainer 218 retains the operating pole 508 in the end. In this place, the second lens module 70 is aligned with the image sensing module 90, visible optical signals are filtered by the second filter 82, infrared signals are focused by the second lens group 602 and received by the image sensing module 90. In this way, the camera module 10 receives images formed by infrared signals.

The sliding grooves 406 can also be defined in the body 20, and the image sensing module 90 can be installed in the body 20. Thus the stationary base 40 of the camera 10 is integrated into the body 20 and the size of the mobile phone 100 is reduced. Additionally, a third lens module (not shown) can be secured in the body 20, the image sensing module 90 can be located in an emitting light path of the third module, the moveable base 50 can be mounted between the third lens module and the image sensing module 90. When the moveable base 50 is moved, either the first filter 81 in the first hole 502 or the second filter 82 in the second hole 602 is selectably aligned with the third lens module and the image sensing module 90. In this way the first lens group 604 and the second lens group 704 can be canceled.

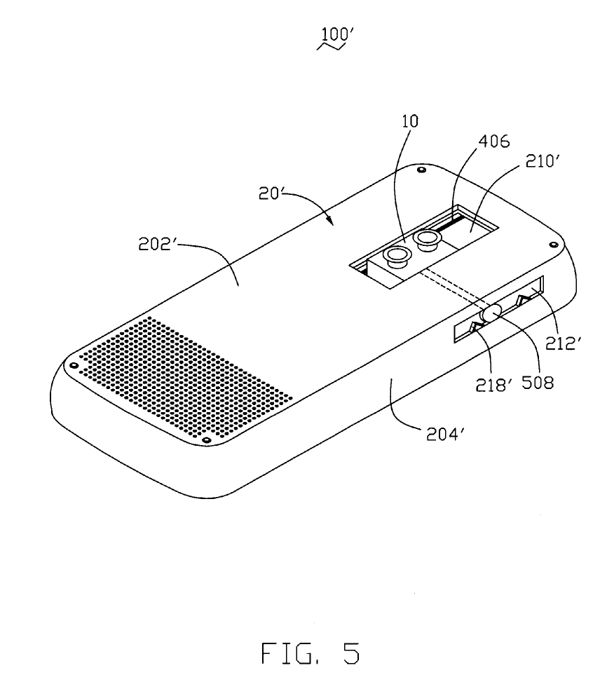

Referring to FIG. 5, a mobile phone 100′ in accordance with a second embodiment of the present portable electronic device includes a body 20′ and a camera module 10′. The body 20′ includes a back 202′ and two side faces 204′. An opening 210 is defined on the back 202′, and the camera module 10′ is installed in the opening 210′. A slot 212′ is defined on either side face 204′, and the slot 212′ is located adjacent to the opening 210′. Two retainers 218′ are formed on two ends of the slot 212′ respectively. The camera module 10′ including a operating pole 508′ is similar to the camera 10 of the mobile phone 100. In assembly, the camera 10′ is mounted into the opening 210′ of the body 20′, and the operating pole 508′ extends out of the slot 212′. Method of using the mobile phone 100′ to take photos is also similar to method of using the mobile phone 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the lens module with grating to the full extent indicated by the broad general meaning of the terms in which the appended claims are expressed.

What is claimed is:

1. A camera module, comprising:
a stationary base;
a moveable base, the moveable base installed in the stationary base, the moveable base being moveable within the stationary base;
a first lens module mounted in the moveable base;
a second lens module mounted in the moveable base; and
an image sensing module installed on the stationary base;
the moveable base being moveable in the stationary base, thus enabling the image sensing module to be selectively aligned with the first lens module or the second lens module.

2. The camera module as claimed in claim 1, wherein an first filter is installed on the moveable base and located in an emitting light path of the first lens module, and an second filter is installed on the moveable base and located in an emitting light path of the second lens module.

3. The camera module as claimed in claim 2, wherein infrared signals are screened from incoming light by the first filter and visible optical signals are allowed to pass through the first filter, infrared signals are allowed to pass through the second filter and visible optical signals are screened from incoming light by the second filter.

4. The camera module as claimed in claim 2, wherein the moveable base defines a first hole and a second hole therein, the first lens module and the first filter are both installed in the first hole, the second lens module and the second filter are both installed in the second hole.

5. The camera module as claimed in claim 4, wherein the moveable base includes two parallel side surfaces, the first hole and the second hole both run through the moveable base, axes of the first hole and the second hole are both parallel to the side surfaces, and screw thread is formed in the first hole and the second hole.

6. The camera module as claimed in claim 5, wherein the moveable base defines two sliding rails on each side surface, each sliding rail runs through two ends of the moveable base and extends along a line connecting the centers of the first hole and the second hole.

7. The camera module as claimed in claim 6, wherein the stationary base includes a floor board and two side walls, two sliding grooves positioned corresponding to the sliding rails are formed on the side walls, each sliding groove extends along a direction parallel to the floor board and runs through two ends of the stationary base, each sliding rail is engageable with a sliding groove.

8. The camera module as claimed in claim 6, wherein a sliding pole is mounted on a side surface.

9. A camera module, comprising:
a lens module;
a stationary base, the lens module secured on the stationary base;
a moveable base installed on the stationary base and being moveable on the stationary base;
an first filter installed on the moveable base;
an second filter installed on the moveable base; and
an image sensing module located in an emitting light path of the lens module.

10. The camera module as claimed in claim 9, wherein infrared signals are screened from incoming light by the first filter and visible optical signals are allowed to pass through the first filter, infrared signals are allowed to pass through the second filter and visible optical signals are screened from incoming light by the second filter.

11. The camera module as claimed in claim 9, wherein the image sensing module is installed on the stationary base, and the moveable base is mounted between the lens module and the image sensing module.

12. The camera module as claimed in claim 11, wherein the moveable base defines a first hole and a second hole, the first filter is installed in the first hole and the second filter is installed in the second hole.

13. The camera module as claimed in claim 12, when the moveable base moves on the stationary base, either the first filter or the second filter can be selectably aligned with the lens module and the image sensing module.

14. A portable electronic device, comprising:
a body including an opening;
a camera module mounted in the opening, the camera module including a first lens module, a second lens module, a stationary base, a moveable base and an image sensing module;
the moveable base being installed in the stationary base and being moveable within the stationary base; the first lens module and the second lens module being installed on the moveable base, the image sensing module being installed on the stationary base; wherein the moveable base being moveable in the stationary base, thus enabling the image sensing module to be selectively aligned with the first lens module or the second lens module.

15. The portable electronic device as claimed in claim 14, wherein an first filter is installed on the moveable base and located in an emitting light path of the first lens module, an second filter is installed on the moveable base and located in an emitting light path of the second lens module.

16. The portable electronic device as claimed in claim 15, wherein infrared signals are screened from incoming light by the first filter and visible optical signals are allowed to pass through the first filter, infrared signals are allowed to pass through the second filter and visible optical signals are screened from incoming light by the second filter.

17. The camera module as claimed in claim 15, wherein the moveable base defines a first hole and a second hole therein, the first lens module and the first filter are both installed in the first hole, the second lens module and the second filter are both installed in the second hole.

18. The portable electronic device as claimed in claim 14, wherein the body includes a slot, a sliding pole is installed on the moveable base, the sliding pole extends out of the slot and can slide along the slot.

19. The portable electronic device as claimed in claim 18, wherein two retainers are formed at two opposing ends of the slot, when the sliding pole slides to the ends of the slot, the retainers retain the sliding pole.
